(19) United States
(12) Patent Application Publication
(10) Pub. No.: US 2015/0172660 A1
(43) Pub. Date: Jun. 18, 2015

(54) APPARATUSES AND METHODS FOR PROVIDING OPTIMIZED QUANTIZATION WEIGHT MATRICES

(71) Applicant: Magnum Semiconductor, Inc., Milpitas, CA (US)

(72) Inventors: Longji Wang, Waterloo (CA); Lowell Winger, Waterloo (CA)

(73) Assignee: Magnum Semiconductor, Inc., Milpitas, CA (US)

(21) Appl. No.: 14/109,539

(22) Filed: Dec. 17, 2013

(51) Int. Cl. H04N 19/126; H04N 19/189; H04N 19/895; H04N 19/147; H04N 19/18

(52) U.S. Cl. CPC H04N 19/126; H04N 19/147; H04N 19/18; H04N 19/895; H04N 19/189

(57) ABSTRACT

Apparatuses and methods for providing optimized quantization matrices are disclosed herein. An example apparatus may include an encoder. The encoder may be configured to provide a plurality of coefficients based, at least in part, on a frame and to provide an optimized quantization weight matrix based, at least in part, on the plurality of coefficients during a first encoding pass. The encoder may further be configured to quantize the plurality of coefficients in accordance with the optimized quantization weight matrix during a second encoding pass different than the first encoding pass.

### TECHNICAL FIELD

Embodiments of this invention relate generally to video encoding, and examples of providing optimized quantization weight matrices are described herein.

### BACKGROUND

Video signals may be used by a variety of devices, including televisions, broadcast systems, mobile devices, and both laptop and desktop computers. Typically, devices may display video in response to receipt of video or other media signals, often after decoding the signal from an encoded form. Video signals provided between devices are often encoded using one or more of a variety of encoding and/or compression techniques, and video signals are typically encoded in a manner to be decoded in accordance with a particular standard, such as MPEG-2, MPEG-4, and H.264. By encoding video or other media signals and decoding the received signals thereafter, the amount of data needed to transmit video between devices may be reduced.

Video encoding typically includes encoding macroblocks, or other units, of video data. Prediction coding may be used to generate predictive blocks and residual blocks, where the residual blocks represent a difference between a predictive block and the block being coded. Prediction coding may include spatial and/or temporal predictions to remove redundant data in video signals, thereby further increasing the reduction of data. Intracoding for example, is directed to spatial prediction and reducing the amount of spatial redundancy between blocks in a frame or slice. Intercoding, on the other hand, is directed toward temporal prediction and reducing the amount of temporal redundancy between blocks in successive frames or slices. Intercoding may make use of motion prediction to track movement between corresponding blocks of successive frames or slices.

Typically, in encoder implementations, including intracoding and intercoding based implementations, predictive blocks and/or residual blocks may be transformed to provide a set of coefficients, which in turn may be quantized and entropy encoded. It is these quantized, encoded coefficients that may be transmitted between the encoding device and the decoding device.

Quantization may be determinative of the amount of loss that may occur during the encoding of a video stream. The amount of data that is removed from a video signal for the purposes of encoding may be dependent on a quantization weight matrix. Encoders typically employ a default quantization weight matrix specified by a coding standard, although other quantization weight matrices may be specified by a user. A same quantization weight matrix is typically used to encode each frame of a video signal. In this manner, a quantization weight matrix may be suboptimal for encoding one or more frames of the video signal.

### BRIEF DESCRIPTION OF THE DRAWINGS

FIG. 1 is a block diagram of an apparatus according to an embodiment of the present invention.

FIG. 2 is a block diagram of an encoder according to an embodiment of the present invention.

FIG. 3 is a flowchart of a method for providing an optimized a quantization weight matrix according to an embodiment of the present invention.

FIG. 4 is a flowchart of a method for generating an optimized quantization weight matrix according to an embodiment of the present invention.

FIG. 5 is a flowchart of a method for providing a rate-distortion optimized quantization weight matrix according to an embodiment of the present invention.

FIG. 6 is a schematic illustration of a media delivery system according to an embodiment of the present invention.

FIG. 7 is a schematic illustration of a video distribution system that may make use of apparatuses described herein.

### DETAILED DESCRIPTION

Examples of apparatuses and methods for providing optimized quantization weight matrices are described herein. Certain details are set forth below to provide a sufficient understanding of embodiments of the invention. However, it will be clear to one having skill in the art that embodiments of the invention may be practiced without these particular details, or with additional or different details. Moreover, the particular embodiments of the present invention described herein are provided by way of example and should not be used to limit the scope of the invention to these particular embodiments. In other instances, well-known video components, encoder or decoder components, circuits, control signals, timing protocols, and software operations have not been shown in detail in order to avoid unnecessarily obscuring the invention.

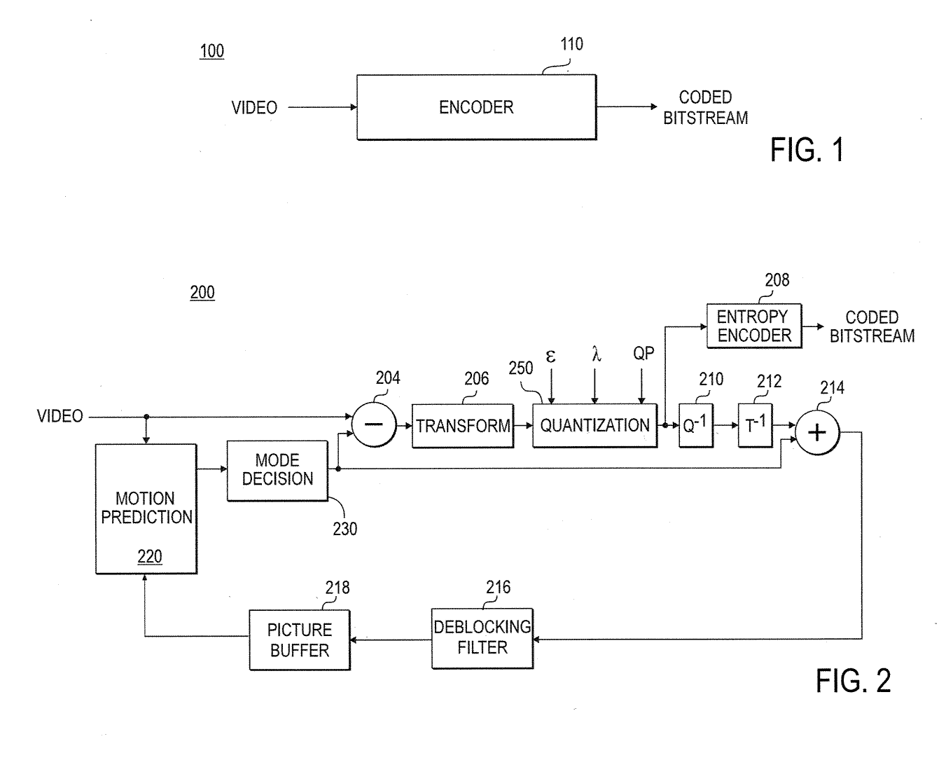

FIG. 1 is a block diagram of an apparatus 100 according to an embodiment of the present invention. The apparatus 100 may include an encoder 110. The encoder 110 may include one or more logic circuits, control logic, logic gates, processors, memory, and/or any combination or sub-combination of the same, and may be configured to encode and/or compress a video signal using one or more encoding techniques, examples of which will be described further below. The encoder 110 may be configured to encode, for example, a variable bit rate signal and/or a constant bit rate signal, and generally may operate at a fixed rate to output a bitstream that may be generated in a rate-independent manner. The encoder 110 may be implemented in any of a variety of devices employing video encoding, including, but not limited to, televisions, broadcast systems, mobile devices, and both laptop and desktop computers.

In at least one embodiment, the encoder 110 may include an entropy encoder, such as a variable-length coding encoder (e.g., Huffman encoder or CAVLC encoder), and/or may be configured to encode data, for instance, at a macroblock level. Each macroblock may be encoded according to a frame type. For example, each macroblock may be encoded in intra-coded mode, inter-coded mode, bidirectionally, or in any combination or subcombination of the same.

By way of example, the encoder 110 may receive and encode a video signal, e.g. video data, that includes a plurality of sequentially ordered coding units (e.g., block, macroblock, slice, frame, field, group of pictures, sequence). The video signal may be encoded in accordance with one or more encoding standards, such as MPEG-2, MPEG-4, H.263, H.264, H.265, and/or HEVC, to provide a coded bitstream. The coded bitstream may in turn be provided to a data bus and/or to a device, such as a decoder or transcoder (not shown in FIG. 1). A video signal may include a transient signal, stored data, or both.

As will be described, for each frame of the video signal, the encoder 110 may provide an optimized quantization weight matrix and quantize the coefficients associated with each macroblock of the frame in accordance with the optimized quantization weight matrix. The optimized quantization weight matrix may be optimized such that a rate-distortion cost, or RD cost, for encoding the macroblock in accordance with the quantization weight matrix is minimized. In some examples, the encoder 110 may provide an optimized quantization weight matrix for a frame during a first pass and may encode each macroblock of the frame using the optimized quantization weight matrix during a second pass.

FIG. 2 is a block diagram of an encoder 200 according to an embodiment of the present invention. The encoder 200 may be used to implement, at least in part, the encoder 110 of FIG. 1, and may further be compliant with one or more known coding standards, such as MPEG-2, H.264, HEVC, and/or H.265 coding standards.

The encoder 200 may include a mode decision block 230, a motion prediction block 220, a subtractor 204, a transform 206, a quantization block 250, an entropy encoder 208, an inverse quantization block 210, an inverse transform block 212, an adder 214, a deblocking filter 216, and a decoded picture buffer 218. The mode decision block 230 may determine an appropriate coding mode for the video signal based on properties of the video signal (e.g., frame type) and a decoded picture buffer signal. The mode decision block 230 may determine an appropriate coding mode on a per frame and/or macroblock basis. The mode decision may include macroblock type, intra-coding modes, inter-coding modes, syntax elements (e.g., motion vectors), and/or one or more quantization parameters.

For each macroblock, the motion prediction block 220 may generate a predictor in accordance with one or more coding standards and/or other prediction methodologies. The predictor may be subtracted from a delayed version of the video signal at the subtractor 204. Using the delayed version of the video signal may provide time for the mode decision block 230 to act. The output of the subtractor 204 may be a residual, e.g. the difference between a block and a prediction for a block.

The transform 206 may perform a transform, such as a discrete cosine transform (DCT), on the residual to transform the residual to the frequency domain and as a result, the transform 206 may provide a coefficient block, such as a DCT coefficient block, including a plurality of coefficients. Each coefficient may correspond to a respective frequency component of the video signal, and accordingly may be located in a frequency bin of the coefficient block associated with the respective frequency component. Generally, the n^{th} coefficient of the coefficient block may be located in the n^{th} frequency bin of the coefficient block. In some examples, transforming the residual may provide a coefficient block having M² coefficients arranged in an M×M array. A transform may, for instance, employ an 8×8 DCT transform such that a coefficient block may include 64 coefficients which may be arranged in an 8×8 array. In some examples, the first coefficient may be a DC coefficient corresponding to a zero frequency component of the video signal. The DC coefficient may represent an average value of the coefficient block. The remaining coefficients may be AC coefficients, with each AC coefficient corresponding to a higher (e.g., non-zero) frequency of the video signal.

The quantization block 250 may receive the coefficient block and quantize the coefficients (e.g., DC coefficient and AC coefficients) of the coefficient block to produce a quantized coefficient block. The quantization provided by the quantization block 250 may be lossy and/or may employ a quantization weight matrix. A quantization weight matrix may include a plurality of values specifying the manner in which each of the coefficients of the coefficient block is quantized. This may allow, for example, a coarser quantization to apply to certain coefficients in the coefficient block, and a finer quantization to be applied to other coefficients in the coefficient block. Because the coefficients may represent certain frequencies of the video signal, a quantization weight matrix may specify the amount of detail preserved for each frequency during quantization.

Accordingly, a quantization weight matrix may include a plurality of values, each of which may correspond to a respective frequency of the video signal. Referring back to the example of an 8×8 coefficient block, a quantization weight matrix applied to the 8×8 coefficient block may include 64 values and further may be represented as an 8×8 matrix such that elements of the coefficient block and elements of the quantization weight matrix have a 1:1 mapping. In some examples, values of each quantization weight matrix element may be specified by a particular coding standard. Taking the MPEG-2 standard as an example, each value of a quantization weight matrix element may range between a minimum value of 16 and a maximum value of 255 and/or may be integer values.

In some examples, the quantization block 250 may quantize coefficients in accordance with an optimized quantization weight matrix. An optimized quantization weight matrix may be optimized for a frame such that an RD cost for encoding the frame is minimized. As will be described in further detail, the quantization block 250 may be based on a multiplier lambda (λ). The multiplier lambda may comprise a Lagrange multiplier and/or may indicate a tradeoff between rate and distortion. In some examples, the optimized quantization weight matrix may be provided by the quantization block 250. In other examples, the optimized quantization weight matrix may additionally or alternatively be provided by an external device, such as pre-processing control logic.

The quantization provided by the quantization block 250 may further employ one or more quantization parameters to employ a particular degree of quantization. For example, in some instances, each value of a quantization weight matrix may be multiplied by the quantization parameter prior to quantization of a coefficient block. Quantization parameters may be fixed or may vary per coding unit (e.g., frame, macroblock), and/or may be provided by rate control logic (not shown in FIG. 2).

In turn, the entropy encoder 208 may encode the quantized coefficient block to provide a coded bitstream. The entropy encoder 208 may be any entropy encoder known by those having ordinary skill in the art or hereafter developed, such as a variable length coding (VLC) encoder, run length coding encoder, or a context-adaptive binary arithmetic coding (CABAC) encoder. In some examples, the entropy encoder 208 may be configured to encode the optimized quantization weight matrix and provide the encoded optimized quantization weight matrix as part of the coded bitstream.

The quantized coefficient block may also be inverse-quantized by the inverse quantization block 210. The inverse-quantized coefficients may be inverse transformed by the inverse transform block 212 to produce a reconstructed residual, which may be added to the predictor at the adder 214 to produce reconstructed video. The reconstructed video may be deblocked by the deblocking filter 216, and provided to the decoded picture buffer 218 for use in future frames, and further may be provided from the decoded picture buffer 218 to the motion prediction block 220 for motion compensation or other mode decision methodologies.

The encoder 200 may operate in accordance with one or more video coding standards, such as H.264. In examples employing coding standards, such as H.264, which employ motion prediction and/or compensation, the encoder 200 may further include a feedback loop having an inverse quantization block 210, an inverse transform 212, and a reconstruction adder 214, a deblocking filter 216, and a picture buffer 218. These elements may mirror elements included in a decoder (not shown) that reverse, at least in part, the encoding process performed by the encoder 200. Additionally, the feedback loop of the encoder may include a prediction block 220 and a decoded picture buffer 218.

In an example operation of the encoder 200, a video signal (e.g. a base band video signal) may be provided to the encoder 200. The subtractor 204 may receive the video signal and subtract a motion prediction signal from the video signal to generate a residual signal. The residual signal may be provided to the transform 206 and processed using a forward transform, such as a DCT. As described, the transform 206 may generate a coefficient block that may be provided to the quantization block 250, and the quantization block 250 may quantize the coefficient block. Quantization of the coefficient block may be employed in accordance with an optimized quantization weight matrix, and quantized coefficients may be provided to the entropy encoder 208 and thereby encoded into a coded bitstream.

The quantized coefficient block may further be provided to the feedback loop of the encoder 200. That is, the quantized coefficient block may be inverse quantized and inverse transformed by the inverse quantization block 210 and the inverse transform 212, respectively, to produce a reconstructed residual. The reconstructed residual may be added to the predictor at the adder 214 to produce reconstructed video, which may be deblocked by the deblocking filter 216, written to the decoded picture buffer 218 for use in future frames, and fed back to the motion prediction block 220. Based, at least in part, on the reconstructed video signals, the motion prediction block 220 may provide a motion prediction signal to the subtractor 204.

While the encoder 200 has been described as including a deblocking filter 216, it will be appreciated by those having skill in the art that one or more deblocking filters may be specified only in particular coding standards. Accordingly, in some instances the encoder 200 may not include the deblocking filter 216 to allow operation in accordance with those coding standards not specifying a deblocking filter.

Accordingly, the encoder 200 of FIG. 2 may provide a coded bitstream based on a video signal, where the coded bitstream is provided by employing optimized quantization weight matrices provided in accordance with embodiments of the present invention. The encoder 200 may be operated in semiconductor technology, and may be implemented in hardware, software, or combinations thereof. In some examples, the encoder 200 may be implemented in hardware with the exception of the mode decision block 230 that may be implemented in software. In other examples, other blocks may also be implemented in software, however software implementations in some cases may not achieve real-time operation.

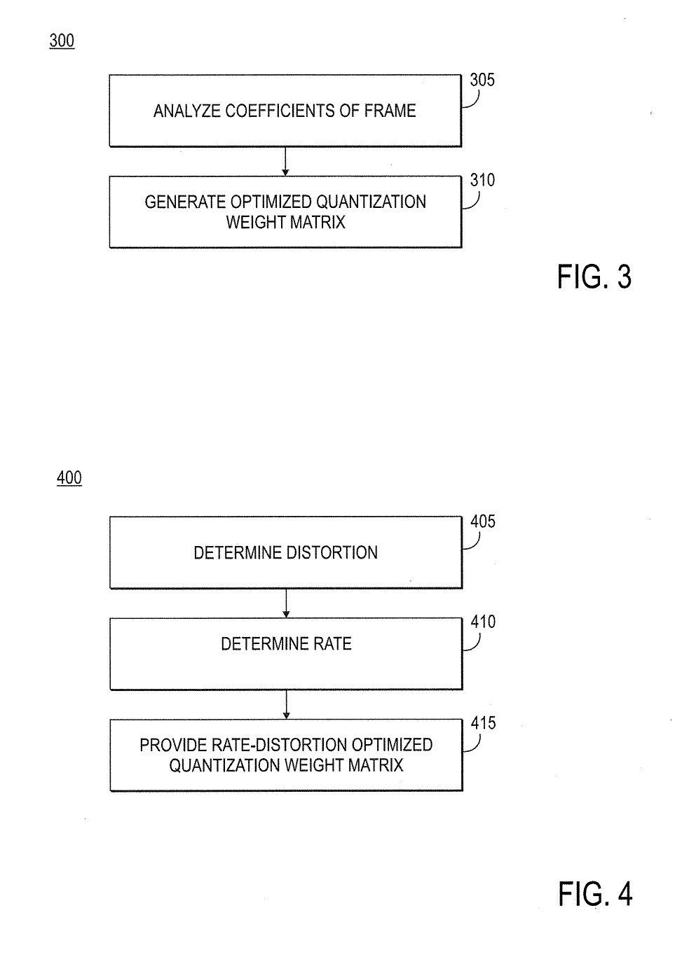

FIG. 3 is a flowchart of a method 300 for providing a quantization weight matrix according to an embodiment of the present invention. The method 300 may be implemented, for instance, using the transform 206 and/or the quantization block 250 of FIG. 2. The method 300 is described herein as being applied at a frame level. It will be appreciated however, that the method 300 may be applied at any coding unit level (e.g., group of pictures level).

At step 305, the coefficients of a frame may be analyzed. For example, the transform 206 may transform a residual of each macroblock of the frame to provide a respective plurality of coefficient blocks (e.g., DCT coefficient block). Each of the coefficient blocks may be provided to the quantization block 250. The quantization block 250 may analyze the coefficients of each coefficient block to determine the number of coefficients located in respective n^{th} frequency bins having a same value. For example, the transform 206 may provide a coefficient histogram indicating the number of coefficients located in respective n^{th} frequency bins having a same value.

In at least one embodiment, the coefficient histogram may be implemented using a two-dimensional array Hist, where each element Hist[n][val_ori] stores the number of coefficients of all n^{th} frequency bins of the frame having the value val_ori. As described, in at least some examples, a coefficient block may include 64 values, each of which is associated with a respective frequency or range of frequencies. Accordingly, the coefficient histogram may include 64 rows, one for each frequency or range of frequencies. Moreover, in some examples, possible values of coefficients may be specified by a particular transform. By way of example, in accordance with an 8×8 DCT transform, coefficient values may range from −2048 to 2048. Accordingly, the coefficient histogram Hist may include 4097 columns.

At step 310, the quantization block 250 may receive the histogram Hist provided at step 305 and employ the histogram Hist to generate an optimized quantization weight matrix. For example, the quantization block 250 may employ the coefficient histogram Hist to determine a distortion and/or a rate for each frequency bin and for each possible value of a quantization weight matrix. The quantization block 250 may subsequently use the respective distortions and rates to calculate an optimized quantization weight matrix. As described, the optimized quantization weight matrix may be provided such that the optimized quantization weight matrix minimizes or reduces a rate-distortion (RD) cost for encoding the frame for a given rate.

Reference is made herein to the transform 206 of FIG. 2 providing coefficients of a frame and the quantization block 250 employing coefficients to provide an optimized quantization weight matrix. In some examples, coefficients, a coefficient histogram Hist, and/or an optimized quantization weight matrix may be provided during a first pass of the encoder 200 and used during a second pass of the encoder 200 to encode each macroblock of a frame. In other examples, coefficients, a coefficient histogram Hist, and/or an optimized quantization weight matrix may be provided by pre-processing control logic located outside of the encoder 200 such that each macroblock of a frame may be encoded in accordance with the optimized quantization weight matrix using a single pass of the encoder 200.

FIG. 4 is a flowchart of a method 400 for generating an optimized quantization weight matrix according to an embodiment of the present invention. The method 400 may be implemented, for instance, using the quantization block 250 of FIG. 2. The method 400 may be used to implement the step 310 of the method 300 of FIG. 3. As described, the optimized quantization weight matrix may be generated during a first pass of an encoder.

At step 405, the quantization block 250 may determine (e.g., calculate) distortions associated with quantizing the coefficients. Letting n represent a frequency bin and p represent a value of a quantization weight matrix element corresponding to frequency bin n, the quantization block 250 may determine distortion for each frequency bin n and each value p. In examples directed to an 8×8 DCT transform, n may correspond to any of 64 frequency bins. In examples directed to encoding in accordance with MPEG-2 encoding, a quantization weight matrix value p may correspond to any value (e.g., integer) ranging from 16 to 255. For example, the quantization block 250 may determine distortion for a particular frequency bin n and value p in accordance with the following equation:

$$D [ n ] [ p ] = {\sum }_{val \_ ori = - VMax}^{VMax} Hist [ n ] [ val\_ori ] \times {[ val\_ori - val\_rec ]}^{2}$$

where VMax represents a maximum absolute value of a coefficient (e.g., 2048), val_ori represents an original value of a coefficient, val_rec represents a reconstructed value of a coefficient, and D[n][p] represents an element of a two-dimensional array D having a value comprising a distortion resulting from encoding coefficients of the frequency bin n with the value p. The reconstructed value of a coefficient val_rec may be determined using a quantization parameter of the frame and a value of p. That is, the value of a reconstructed coefficient val_rec may be determined by quantizing and inverse quantizing the coefficient in accordance with a quantization parameter and the value p, as described.

Accordingly, for each coefficient value, the quantization block 250 may square the difference between an original coefficient value and the reconstructed coefficient value (or utilize another distortion metric in some examples) and multiply the result by the number of coefficients in the n^{th} frequency bin having the original coefficient value as indicated by the coefficient histogram Hist. This determination may be iteratively repeated for each frequency bin n (e.g., 0 to 63) and for each p value (e.g., 16 to 255). Accordingly, a distortion amount associated with a particular coefficient may be calculated and weighted (e.g., multiplied by) in accordance with the number of times that particular coefficient may occur.

Once distortions for the array D have been determined, at step 410, the quantization block 250 may determine (e.g., estimate) rates for encoding quantized coefficients. In some examples, the quantization block 250 may estimate each rate based on the entropy of quantized coefficients. Thus, the quantization block 250 may determine a rate for each frequency bin n and each value p. For example, the quantization block 250 may determine a rate for each frequency bin n and each value p in accordance with the following equation:

$$R [ n ] [ p ] = - {\sum }_{i = val \_ quant \_ m i n}^{val \_ quant \_ ma x} c ( i ) {log}_{2} ( \frac{c ( i )}{num\_blk} ) , ∀ c ( i ) > 0$$

where val_quant_min represents the minimum possible value of a quantized DCT coefficient, val_quant_max represents the maximum possible value of a quantized coefficient, c(i) represents the number of quantized coefficients of the n^{th} frequency bin having a value of i, num_blk represents the number of blocks (e.g., 8×8 blocks) in the frame, and R[n] [p] represents an element of a two-dimensional array R having a value including a rate for encoding quantized coefficients of the frequency bin n with the value p. It will be apparent to those having ordinary skill in the art that the number of quantized coefficients of the n^{th} frequency bin having a value of i may be determined from the coefficient histogram Hist as quantizing coefficients in a same frequency bin using a same value p will provide a same result.

Accordingly, for each quantized coefficient value, the quantization block 250 may divide the number of quantized coefficients in the n^{th} frequency bin having a particular value by the number of blocks of the frame, and perform a natural logarithm on the result. The subsequent result may be multiplied by the number of quantized coefficients in the n^{th} frequency bin having a particular value. This determination may be iteratively repeated for each frequency bin n and for each p value.

Alternatively, each element R[n][p] of the array R may be determined using the actual rate for encoding quantized coefficients in each frequency bin n. For example, the quantization block 250 may determine a rate for encoding coefficients in the n^{th} frequency bin by utilizing coefficient coding tables provided by a particular coding standard (e.g., MPEG-2). Because during entropy coding quantized coefficients may first be converted to the form of (run, level) in accordance with run-level coding, selecting an average run value for non-zero quantized coefficient values may be required in some examples to determine each element R[n][p].

At step 415, the quantization block 250 may provide (e.g., generate) a rate-distortion optimized quantization weight matrix based on the distortions and rates determined at steps 405 and 410, respectively.

Generally, total distortion resulting from encoding coefficients of a frame may be represented using a sum of the distortions resulting from encoding coefficients of each frequency bin. Accordingly, the total distortion resulting from encoding a frame may be determined by summing distortion for each frequency bin n and/or in accordance with the following formula:

$$d ( F , {F}^{′} ) = {\sum }_{n}^{ } D [ n ] [ p ]$$

where d(F,F′) represents the distortion resulting from encoding a frame (e.g., distortion between an original frame F and a reconstructed frame F′), and D[n][p] represents an element of a two-dimensional array D having a value comprising a distortion resulting from encoding coefficients of the frequency bin n with the value p, as described.

Moreover, because transforms, such as a DCT transform, may provide uncorrelated coefficients, a total rate for encoding coefficients of a frame may comprise a sum of the rates for encoding coefficients of each frequency n. Accordingly, the total rate for encoding a frame may be determined by adding rate for each frequency bin n and/or in accordance with the following formula:

$$r ( Q ) = {\sum }_{n}^{ } R [ n ] [ p ]$$

where r(Q) represents the rate for encoding the frame with quantization weight matrix Q, and R[n][p] represents an element of a two-dimensional array R having a value comprising a rate for encoding quantized coefficients of the frequency bin n with the value p as the element in Q corresponding to frequency bin n.

Additionally, providing an optimized quantization weight matrix may be modeled as a rate constrained optimization where the total frame distortion is minimized for a target rate Rcoeff. The constrained optimization may be modeled in accordance with the following formula:

$${min}_{Q} d ( F , {F}^{′} ) ) \vert r ( Q ) \leq {R}_{coeff}$$

where min(d(F,F′Q)) represents a minimized total distortion for encoding a frame, r(Q) represents a total rate (e.g, bit count) for encoding the frame, and Rcoeff represents a target rate.

Accordingly, the constrained optimization may be modeled by minimizing total distortion such that the rate for encoding the frame is less than or equal to the target rate.

As described, the quantization block 250 may receive a multiplier lambda that may be used to provide an optimized quantization weight matrix. In some examples, lambda may be used to convert the constrained optimization into an unconstrained optimization. For example, the rate constrained optimization may instead be modeled as an unconstrained optimized in accordance with the following equation:

$${min}_{Q} \{ J ( λ ) = d ( F , {F}^{′} ) + λ \times r ( Q ) \}$$

where J(λ) represents the rate-distortion cost (e.g., Lagrange cost) to be minimized, d(F,F′) represents the distortion resulting from encoding the frame, λ represents the multiplier lambda, and r(Q) represents the rate for encoding the frame.

As will be described in more detail, the unconstrained optimization may be solved to provide an optimized quantization weight matrix. Because, as described above, total distortion may be determined by summing distortions for each frequency bin n and total rate may be determined by summing rates for each frequency bin n, the unconstrained optimization may be solved by evaluating each value p for each frequency bin n using a particular value of the multiplier lambda.

Evaluating each value p for each frequency bin n using a particular value of the multiplier lambda may provide a candidate quantization weight matrix. If the rate for encoding a frame with the candidate quantization weight matrix satisfies a target rate Rcoeff (e.g., is equal to the target rate, and/or is within a tolerance of the target rate), the resulting quantization weight matrix may be identified and/or provided as an optimized quantization weight matrix for the frame. If the rate does not satisfy the target rate Rcoeff, the multiplier lambda may be adjusted and the process reiterated. The multiplier lambda may be iteratively adjusted until a quantization weight matrix satisfying the target rate is provided. Because lambda and a target rate Rcoeff have a one-to-one correspondence, the iterative process of adjusting lambda to provide an optimized quantization weight matrix may be guaranteed to converge.

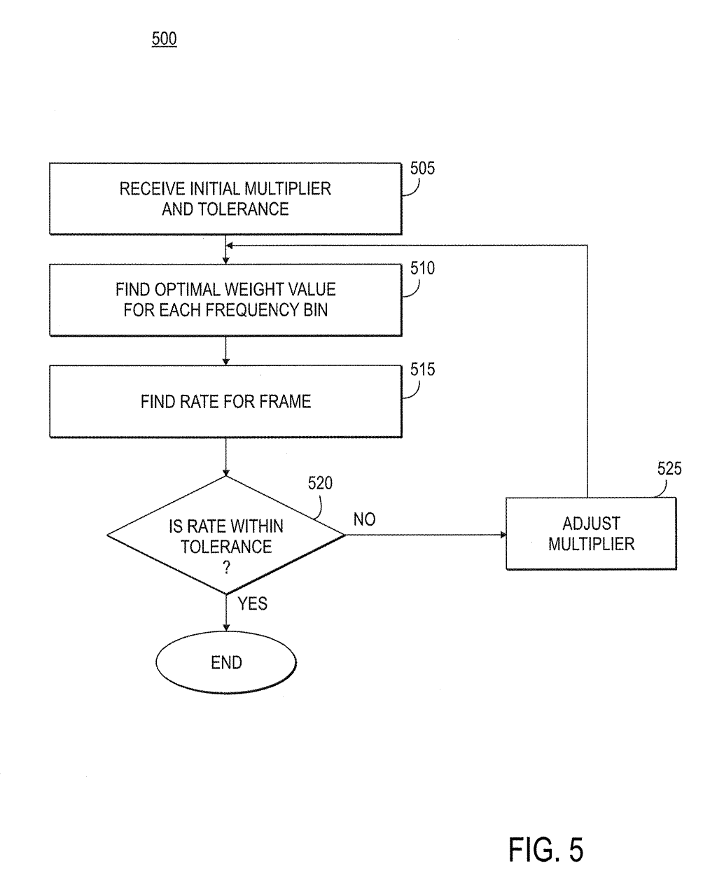

FIG. 5 is a flowchart of a method 500 for providing a rate-distortion optimized quantization weight matrix according to an embodiment of the present invention. The method 500 may be implemented, for instance, using the quantization block 250 of FIG. 2. The method 500 may be used to implement the step 415 of the method 400 of FIG. 4.

At step 505, the quantization block 250 may receive a tolerance epsilon (8) and an initial multiplier lambda. The tolerance epsilon and/or the initial multiplier lambda may be provided by one or more of the components of the encoder 200, such as the mode decision block 230, or may be provided by external circuitry, such as pre-processing control logic. In other examples, the tolerance epsilon and/or the initial multiplier lambda may be stored and/or generated by the quantization block 250.

At step 510, an optimal value w may be determined for each frequency bin n. For example, the quantization block 250 may determine an RD cost for encoding coefficients of each frequency bin n with each value p. The quantization block 250 may determine an RD cost for encoding coefficients with of each frequency bin n for each value p in accordance with the following equation:

J(λ,n)=D[n][p]+λ×R[n][p]

where J(λ,n) represents the rate-distortion cost for encoding coefficients a frequency bin n using a particular value of multiplier lambda, D[n][p] represents a distortion resulting from encoding coefficients of the frequency bin n with the value p, λ, represents the multiplier lambda, and R[n] [p] represents a rate for encoding coefficients of the frequency bin n with the value p. In other examples, other RD cost formulae may be used.

Accordingly, for each frequency bin n (e.g., 0 to 63), once an RD score has been determined for each value p (e.g., 16 to 255), the quantization block 250 may identify a value w, the value p which satisfies a particular RD criteria (e.g. minimal RD cost). This process may be iteratively repeated until a value w has been determined for each frequency bin n. Each of the values w may comprise an element of a candidate quantization weight matrix.

As described with respect to steps 405 and 410 of FIG. 4, the array D may include a plurality of elements D[n][p], each of which indicates distortion resulting from encoding of the frequency bin n with the value p, and the rate array R may include a plurality of elements R[n] [p], each of which indicates a rate for encoding coefficients of the frequency bin n with the value p. Thus, determining a minimizing RD score for each frequency bin n, as described with respect to step 510, may include employing D and R to “lookup” respective rates and distortions for each frequency bin n and value p.

Once a candidate quantization weight matrix has been provided, at step 515, the quantization block 250 may determine (e.g., estimate) a rate for encoding a frame using the candidate quantization weight matrix. For example, a rate may be determined for a frame by summing rates for each frequency bin n using a respective value w of the candidate quantization weight matrix. A rate may be determined in accordance with the following equation:

$$r ( λ , Q ) = {\sum }_{n}^{ } R [ n ] [ w ]$$

where r(λ,Q) represents the rate for encoding a frame in accordance with the candidate quantization weight matrix and R[n] [w] represents a rate for encoding coefficients of the frequency bin n with the value w corresponding to frequency bin n in the candidate quantization weight matrix.

Accordingly, for each frequency bin n, the rate for encoding the coefficients of the frequency bin n with the value w may be determined. Each of the rates may be summed to provide a rate for encoding a frame.

At step 520, the quantization block 250 may determine whether the rate for encoding the frame is within the tolerance epsilon of the target rate Rcoeff. The quantization block 250 may determine whether the rate is with the tolerance epsilon in accordance with the following equation:

|r(λ,Q)−R_{coeff}|<ε

where r(λ,Q) represents the rate for encoding the frame with a particular multiplier lambda and with candidate quantization weight matrix Q, and Rcoeff represents the target rate. Thus, if the difference between the rate for encoding the frame and the target rate Rcoeff is within the tolerance epsilon provided to the quantization block 250 at the step 505, the candidate quantization weight matrix Q may be identified and/or provided as the optimized quantization weight matrix for the frame and the method 500 may end.

If the difference is not within the tolerance epsilon, the multiplier lambda may be adjusted at step 525 and steps 510-520 may be repeated using the adjusted multiplier lambda. In some examples, the multiplier lambda may be bounded by a range and may be adjusted using a binary search algorithm. In this manner, a value of the multiplier lambda may be iteratively adjusted until an optimized quantization weight matrix is provided.

While examples are described herein as being applied to frames, embodiments of the present invention may be applied to other coding units as well, such as fields. Moreover, examples described herein may be applied at a component level such that an optimized quantization weight matrix may be determined for each component or for less than all components. For example, in at least one embodiment, an optimized quantization matrix may be determined and/or applied only for a luminance component of a frame. In other examples, an optimized quantization matrix may be determined and/or applied only for chrominance components of a frame.

In some examples, a quantization step size for each frequency bin may be obtained using rate-distortion optimization based on the target rate. Once the quantization step size has been determined for each frequency bin, an optimization weight matrix may be derived for each frame and a quantization parameter may be derived for each macroblock using the optimized quantization step sizes.

In some examples, a frame may comprise an inter-coded frame (e.g., P frame or B frame) or an intra-coded frame (e.g., I frame). In at least one embodiment, for each intra-coded frame, an optimized quantization weight matrix may be provided for the frame as described herein. For each inter-coded frame, intra-coded coefficients and inter-coded coefficients of the inter-coded frame may be employed separately. For example, a first optimized quantization weight matrix may be provided using intra-coded coefficients of the inter-coded frame and a second optimized quantization weight matrix may be provided using inter-coded coefficients of the inter-coded frame. Each intra-coded macroblock of the inter-coded frame may be encoded using the first optimized quantization weight matrix and each inter-coded macroblock may be encoded using the second optimized quantization weight matrix.

Operation of methods 300, 400, and 500 has been described herein as employing a transform and a quantization block, such as the transform 206 and the quantization block 250 of FIG. 2. It will be appreciated, however, that in other embodiments other components of the encoder 200 and/or pre-processing control logic (not shown) may be employed to perform one or more respective steps of the methods 300, 400 and 500.

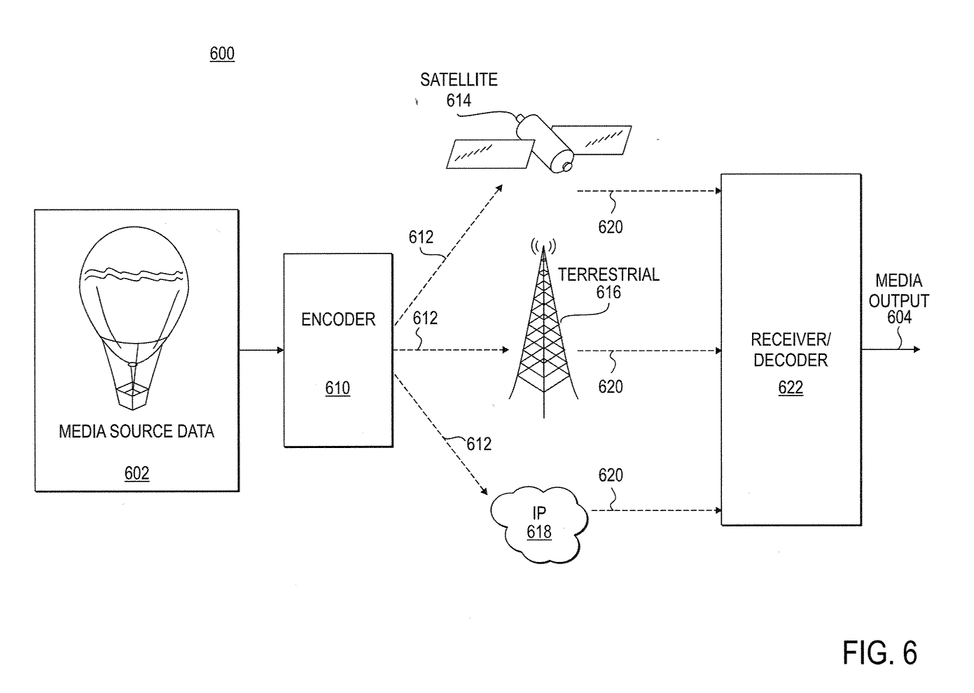

FIG. 6 is a schematic illustration of a media delivery system 600 in accordance with embodiments of the present invention. The media delivery system 600 may provide a mechanism for delivering a media source 602 to one or more of a variety of media output(s) 604. Although only one media source 602 and media output 604 are illustrated in FIG. 6, it is to be understood that any number may be used, and examples of the present invention may be used to broadcast and/or otherwise deliver media content to any number of media outputs.

The media source data 602 may be any source of media content, including but not limited to, video, audio, data, or combinations thereof. The media source data 602 may be, for example, audio and/or video data that may be captured using a camera, microphone, and/or other capturing devices, or may be generated or provided by a processing device. Media source data 602 may be analog and/or digital. When the media source data 602 is analog data, the media source data 602 may be converted to digital data using, for example, an analog-to-digital converter (ADC). Typically, to transmit the media source data 602, some mechanism for compression and/or encryption may be desirable. Accordingly, an apparatus 610 may be provided that may filter and/or encode the media source data 602 using any methodologies in the art, known now or in the future, including encoding methods in accordance with video standards such as, but not limited to, MPEG-2, H.264, HEVC, or combinations of these or other encoding standards. The apparatus 610 may be implemented with embodiments of the present invention described herein. For example, the apparatus 610 may be implemented using the apparatus 100 of FIG. 1.

The encoded data 612 may be provided to a communications link, such as a satellite 614, an antenna 616, and/or a network 618. The network 618 may be wired or wireless, and further may communicate using electrical and/or optical transmission. The antenna 616 may be a terrestrial antenna, and may, for example, receive and transmit conventional AM and FM signals, satellite signals, or other signals known in the art. The communications link may broadcast the encoded data 612, and in some examples may alter the encoded data 612 and broadcast the altered encoded data 612 (e.g. by re-encoding, adding to, or subtracting from the encoded data 612). The encoded data 620 provided from the communications link may be received by a receiver 622 that may include or be coupled to a decoder. The decoder may decode the encoded data 620 to provide one or more media outputs, with the media output 604 shown in FIG. 6. The receiver 622 may be included in or in communication with any number of devices, including but not limited to a modem, router, server, set-top box, laptop, desktop, computer, tablet, mobile phone, etc.

The media delivery system 600 of FIG. 6 and/or the apparatus 610 may be utilized in a variety of segments of a content distribution industry.

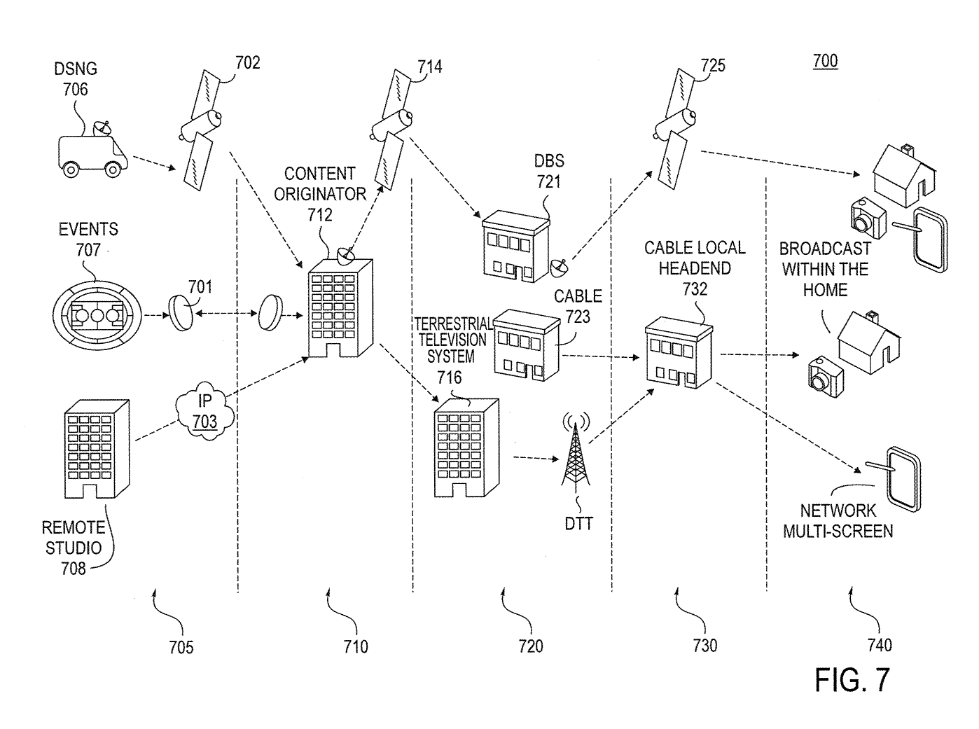

FIG. 7 is a schematic illustration of a video distribution system 700 that may make use of apparatuses described herein. The video distribution system 700 includes video contributors 705. The video contributors 705 may include, but are not limited to, digital satellite news gathering systems 706, event broadcasts 707, and remote studios 708. Each or any of these video contributors 705 may utilize an apparatus described herein, such as the apparatus 100 of FIG. 1, to encode media source data and provide encoded data to a communications link. The digital satellite news gathering system 706 may provide encoded data to a satellite 702. The event broadcast 707 may provide encoded data to an antenna 701. The remote studio 708 may provide encoded data over a network 703.

A production segment 710 may include a content originator 712. The content originator 712 may receive encoded data from any or combinations of the video contributors 705. The content originator 712 may make the received content available, and may edit, combine, and/or manipulate any of the received content to make the content available. The content originator 712 may utilize apparatuses described herein, such as the apparatus 100 of FIG. 1, to provide encoded data to the satellite 714 (or another communications link). The content originator 712 may provide encoded data to a digital terrestrial television system 716 over a network or other communication link. In some examples, the content originator 712 may utilize a decoder to decode the content received from the contributor(s) 705. The content originator 712 may then re-encode data and provide the encoded data to the satellite 714. In other examples, the content originator 712 may not decode the received data, and may utilize a transcoder to change a coding format of the received data.

A primary distribution segment 720 may include a digital broadcast system 721, the digital terrestrial television system 716, and/or a cable system 723. The digital broadcasting system 721 may include a receiver, such as the receiver 622 described with reference to FIG. 6, to receive encoded data from the satellite 714. The digital terrestrial television system 716 may include a receiver, such as the receiver 622 described with reference to FIG. 6, to receive encoded data from the content originator 712. The cable system 723 may host its own content which may or may not have been received from the production segment 710 and/or the contributor segment 705. For example, the cable system 723 may provide its own media source data 602 as that which was described with reference to FIG. 6.

The digital broadcast system 721 may include an apparatus, such as the apparatus 610 described with reference to FIG. 6, to provide encoded data to the satellite 725. The cable system 723 may include an apparatus, such as the apparatus 100 of FIG. 1, to provide encoded data over a network or other communications link to a cable local headend 732. A secondary distribution segment 730 may include, for example, the satellite 725 and/or the cable local headend 732.

The cable local headend 732 may include an apparatus, such as the apparatus 100 of FIG. 1, to provide encoded data to clients in a client segment 640 over a network or other communications link. The satellite 725 may broadcast signals to clients in the client segment 740. The client segment 740 may include any number of devices that may include receivers, such as the receiver 622 and associated decoder described with reference to FIG. 6, for decoding content, and ultimately, making content available to users. The client segment 740 may include devices such as set-top boxes, tablets, computers, servers, laptops, desktops, cell phones, etc.

Accordingly, filtering, encoding, and/or decoding may be utilized at any of a number of points in a video distribution system. Embodiments of the present invention may find use within any, or in some examples all, of these segments.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus comprising:
an encoder configured to:
provide a plurality of coefficients based, at least in part, on a frame;
provide an optimized quantization weight matrix based, at least in part, on the plurality of coefficients during a first encoding pass; and
quantize the plurality of coefficients in accordance with the optimized quantization weight matrix during a second encoding pass different than the first encoding pass.

2. The apparatus of claim 1, wherein the encoder is further configured to provide the optimized quantization weight matrix based, at least in part, on a multiplier indicative of a rate-distortion tradeoff.

3. The apparatus of claim 1, wherein a rate for encoding the plurality of coefficients in accordance with the optimized quantization weight matrix is within a tolerance of a target rate.

4. The apparatus of claim 1, wherein the optimized quantization weight matrix is a first optimized quantization weight matrix and the frame is inter-coded, wherein the encoder is further configured to quantize intra-coded coefficients of the frame using the first optimized quantization weight matrix and to quantize inter-coded coefficients of the frame using a second optimized quantization weight matrix.

5. The apparatus of claim 1, wherein the optimized quantization weight matrix is based, at least in part, on a plurality of minimized rate-distortion costs, each of the minimized rate-distortion costs corresponding to a respective frequency bin.

6. The apparatus of claim 1, wherein the optimized quantization matrix corresponds to a luminance component, a chrominance component, or a combination thereof.

7. The apparatus of claim 1, wherein the encoder is configured to operate in accordance with the MPEG-2 coding standard, the H.264 coding standard, the HEVC coding standard, or a combination thereof.

8. An apparatus comprising:
an encoder configured to receive a multiplier, the encoder further configured to determine a plurality of weight values based, at least in part, on the multiplier, each of the plurality of weight values minimizing a respective rate-distortion cost for encoding coefficients of a respective frequency bin, the encoder further configured to determine a rate for encoding the coefficients based, at least in part, on the plurality of weight values;
wherein the encoder is further configured to encode the plurality of coefficients in accordance with the plurality of weight values responsive, at least in part, to determining that a difference between the rate for encoding the coefficients and a target rate is less than a tolerance.

9. The apparatus of claim 8, wherein the encoder is further configured to adjust the multiplier responsive, at least in part, to determining that the difference between the estimated rate and the target rate is within the tolerance.

10. The apparatus of claim 9, wherein the encoder is further configured to adjust the multiplier in accordance with a binary search algorithm.

11. The apparatus of claim 8, wherein the encoder is further configured to encode the plurality of coefficients in accordance with a fixed quantization parameter.

12. The apparatus of claim 8, wherein the encoder is further configured to sum a plurality of rates, each of the rates comprising a rate for encoding coefficients of a respective frequency bin.

13. The apparatus of claim 8, wherein the encoder is further configured to encode the plurality of coefficients in accordance with the plurality of weight values to provide a coded bitstream, the encoder further configured to encode the plurality of weight values and provide the encoded plurality of weight values in the coded bitstream.

14. A method comprising:
receiving a multiplier indicative of a rate-distortion tradeoff;
determining a plurality of weight values, each weight value minimizing a rate-distortion cost for encoding coefficients of a respective frequency bin of a plurality of frequency bins in accordance with the multiplier;
generating a candidate quantization weight matrix based, at least in part, on the plurality of weight values;
determining a plurality of rates using the candidate quantization weight matrix, each rate of the plurality of rates comprising a rate for encoding coefficients of a respective frequency bin of the plurality of frequency bins;
summing each rate of the plurality of rates to provide a total rate;
determining whether the total rate is within a tolerance of a target rate;
if the rate is within the tolerance of the target rate, identifying the candidate quantization weight matrix as an optimized quantization weight matrix; and
if the rate is not within the tolerance, adjusting the multiplier.

15. The method of claim 14, further comprising:
determining a plurality of distortions for each frequency bin of the plurality of frequency bins; and
determining a plurality of rates for each frequency bin of the plurality of frequency bins.

16. The method of claim 14, further comprising:
encoding the coefficients of each frequency bin of the plurality of frequency bins in accordance with the optimized quantization weight matrix.

17. The method of claim 14, wherein said providing the plurality of weight values to provide an optimized quantization weight matrix comprises providing the optimized quantization weight matrix an encoder from pre-processing control logic.

18. A method comprising:
determining a plurality of distortions for each of a plurality of frequency bins during a first encoding pass;
determining a plurality of rates for each of a plurality of frequency bins during the first encoding pass;
determining a minimized rate-distortion cost for each of the plurality of frequency bins during the first encoding pass to provide a rate-distortion optimized quantization weight matrix, each minimized rate-distortion cost based, at least in part, on a respective plurality of distortions and a respective plurality of rates; and
encoding coefficients in accordance with the rate-distortion optimized quantization weight matrix during a second encoding pass.

19. The method of claim 18, wherein determining a minimized rate-distortion cost for each of the plurality of frequency bins during the first encoding pass comprises:
determining a minimized rate-distortion cost for each of the plurality of frequency bins, the minimized rate, each minimized rate-distortion cost based, at least in part, on a multiplier.

20. The method of claim 20, wherein encoding coefficients in accordance with the rate-distortion optimized quantization weight matrix during a second encoding pass comprises:
quantizing the coefficients in accordance with the rate-distortion optimized quantization weight matrix; and
encoding the coefficients and the rate-distortion optimized quantization weight matrix to provide a coded bitstream.
